(19) United States
(12) Patent Application Publication
(10) Pub. No.: US 2009/0254631 A1
(43) Pub. Date: Oct. 8, 2009

(54) DEFINING CLIPPABLE SECTIONS OF A NETWORK DOCUMENT AND SAVING CORRESPONDING CONTENT

(75) Inventors: Raju Jain, Woodinville, WA (US); Michael Eric Deem, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/099,765

(22) Filed: Apr. 8, 2008

(51) Int. Cl. G06F 3/048; G06F 15/16

(52) U.S. Cl. 709/217; 715/856; 715/764

(57) ABSTRACT

A system and a method may be provided. The system may include a server and one or more user processing devices. The user processing devices may execute an application, such as, for example, a browser. Via the application, a user may define clippable sections of a network document without executing any scripts. The defined clippable sections may be stored on a user processing device or on a server. When viewing a network document, a user may select a portion of the network document corresponding to a defined clippable section to cause corresponding content to be saved to a list. The list may be stored on the user processing device or on the server. When the list is stored on the server, the list may be made shareable with other users.

### BACKGROUND

Clipping services may permit one to save content of a clippable section of a network document, such as, for example, a web page, or any document that is available over a network. Some clipping services may permit a portion of content of a network document to be copied and saved via, for example, a cut, copy and paste type metaphor. In other clipping services, custom scripts may be written and downloaded to be run in a context of the network document. The custom scripts may search the network document for items that may be clipped or copied to the clipping service. However, the custom scripts may not be suitable for all varieties of network documents that may exist.

Use of custom scripts may create security, privacy, and trust issues. For example, if a custom script is shared among a set of users, an unscrupulous user may create a custom script, which may be used by unsuspecting users. The custom script may copy passwords, or other information, which may be sent to a network service where the unscrupulous user may access the passwords.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In embodiments consistent with the subject matter of this disclosure, a system and a method may be provided for defining clippable sections of a network document. A network document may be displayed on a processing device executing an application, such as, for example, a network browser, or other application. Via the application, a user may indicate a desire to define clippable sections which may be applicable to the network document. The clippable sections may be defined by walking through a document object model of the network document to find a repeating pattern. A visual indication may be provided to illustrate a current definition of the clippable sections. The clippable sections may be defined without executing any scripts.

In some embodiments, a selection of a portion of a network document corresponding to a defined clippable section may cause content of the clippable section to be saved to a list. The list may be stored on a processing device executing the above-mentioned application or the list may be saved on a remote processing device, such as, for example, a server. The list may be made accessible to other users.

In other embodiments, defined clippable sections may be stored on a remote processing device, such as a server. Ones of the defined clippable sections may be made shareable with other users. Users' processing devices may provide, to the remote processing device, usage information with respect to usage of ones of the defined clippable sections on the users' processing devices. The remote processing device may determine most popular similar ones of the defined clippable sections and may automatically download the most popular similar ones of the defined clippable sections to the users' processing devices.

### DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates an exemplary operating environment for embodiments consistent with the subject matter of this disclosure.

FIG. 2 illustrates an exemplary processing device which may implement embodiments consistent with the subject matter of this disclosure.

FIG. 3 shows an exemplary display, which may be presented on a display monitor of a user's processing device.

FIG. 4 illustrates a menu which may be displayed on a display monitor of a user's processing device when a definition of clippable sections is either edited or added.

FIG. 5 shows an exemplary display which may be presented on a user's processing device.

FIGS. 6-8, 10 and 12 are flowcharts illustrating exemplary processing which may be performed in a user's processing device.

FIG. 9 illustrates an exemplary display of a network document including clippable sections.

FIG. 11 illustrates an exemplary list of defined clippable sections displayed as a menu.

FIGS. 13-15 are flowcharts of exemplary processes which may be performed in a server in an embodiment consistent with the subject matter of this disclosure.

### DETAILED DESCRIPTION

Embodiments are discussed in detail below. While specific implementations are discussed, it is to be understood that this is done for illustration purposes only. A person skilled in the relevant art will recognize that other components and configurations may be used without parting from the spirit and scope of the subject matter of this disclosure.

### Overview

Embodiments consistent with the subject matter of this disclosure may provide a method and a system for defining clippable sections of a network document and for saving content corresponding to a selected defined clippable section. In some embodiments, clippable sections of a network document may be defined without executing any scripts. For example, a user may access and view a network document on a display of a processing device by executing an application, such as, for example, a network browser or other application. The user may define clippable sections of the network document by selecting a portion of the network document including an element, thereby causing the processing device to walk through a Document Object Model (DOM) of the network document. The selected element, along with similar elements, may then be set as clippable sections of the network document. Each time an element is selected, all elements similar to the selected element may be displayed with a visual indication, such as, for example, a dashed border, or other visual indication. In some embodiments, additional controls may be displayed. For example, text may be displayed identifying clipping elements. The text may be XPath text, or other text. A user may edit the XPath text, to more finely control which of the elements are clippable. In some embodiments, text representing different network document elements may be displayed. Selection of any one of the network document elements may revise the defined clippable sections.

A user may save content corresponding to a defined clippable section of a network document by selecting the defined clippable section. The content may be saved to a list, which may be stored locally, with respect to the processing device, or may be sent to a remote processing device, such as, for example, a server, which may store the content to a list. In embodiments in which the list is saved to a remote processing device, the list may be shareable, such that other users may access the list.

In some embodiments, a definition of clippable sections of one or more network documents may be saved, either locally, on a processing device of a user, or remotely, on a remote processing device. When the definition of the clippable sections is saved to the remote processing device, the definition of the clippable sections may be shared, such that other users may access the definition of the clippable sections and may load the definition of the clippable sections to another processing device.

In addition to saving content corresponding to a defined clippable section, information with respect to a complete network document, or a selected section of a network document, not necessarily corresponding to a defined clippable section, may be stored to a list on a local processing device or a remote processing device. When saving content corresponding to a complete network document, an address of the network document and a title of the network document may be stored to the list. When saving a selected section of a network document, a portion of the network document may be selected by using a pointing device, such as, for example, a computer mouse, or other pointing device, and clicking and dragging an area surrounding the portion of the network document. In other embodiments, other methods may be used to select a portion of a network document.

In an embodiment in which definitions of clippable sections may be stored on a remote processing device, such as a server or other processing device, the remote processing device may receive usage information from users' processing devices. The remote processing device may determine which clipping definitions are most popular and may automatically download, to the users' processing devices, up to a predetermined number of most popular ones of the clipping definitions.

### Exemplary Operating Environment

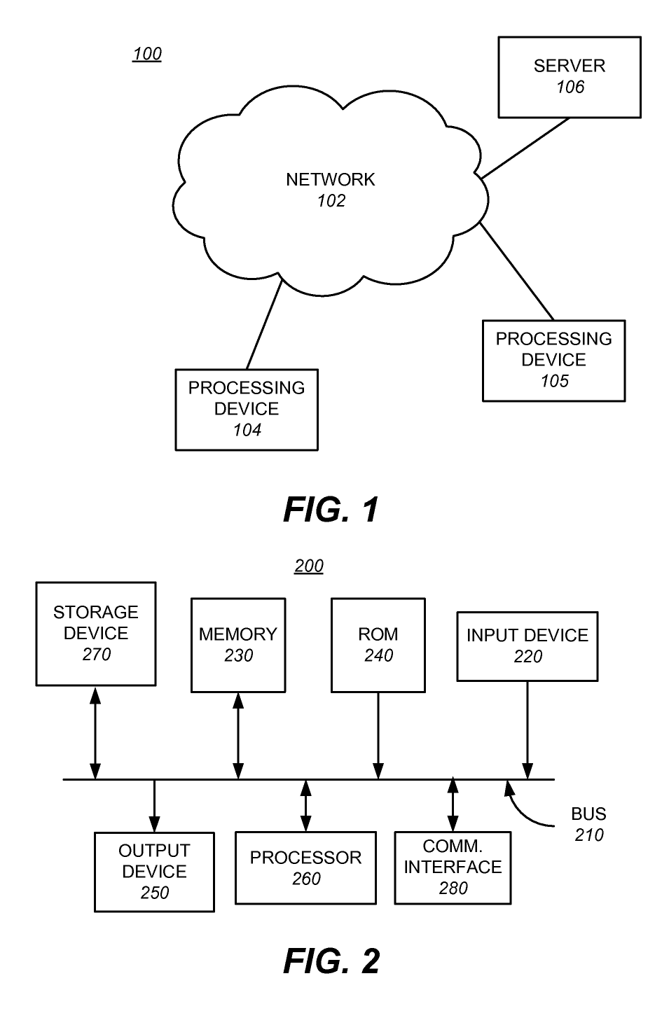

FIG. 1 illustrates exemplary operating environment 100 for embodiments consistent with the subject matter of this disclosure. Operating environment 100 may include a network 102, a processing device 104, a processing device 105, and a server 106.

Processing devices 104 and 105 may be users' processing devices, such as, for example, desktop personal computers (PC), laptop PCs, handheld processing devices, or other processing devices.

Network 102 may be a single network or a combination of networks, such as, for example, the Internet or other networks. Network 102 may include a wireless network, a wired network, a packet-switching network, a public switched telecommunications network, a fiber-optic network, other types of networks, or any combination of the above.

Server 106 may be a single server or a group of servers configured to work together. In embodiments in which server 106 includes a group of servers, the servers may be configured as a server farm.

Although FIG. 1 illustrates an environment having two processing devices 104, 105 and one server 106, various configurations may include more or fewer of processing devices 104, 105 and server 106.

### Exemplary Processing Device

FIG. 2 is a functional block diagram of an exemplary processing device 200, which may be used in embodiments consistent with the subject matter of this disclosure to implement processing device 104, processing device 105, and/or server 106. Processing device 200 may include a bus 210, an input device 220, a memory 230, a read only memory (ROM) 240, an output device 250, a processor 260, a storage device 270, and a communication interface 280. Bus 210 may permit communication among components of processing device 200.

Processor 260 may include at least one conventional processor or microprocessor that interprets and executes instructions. Memory 230 may be a random access memory (RAM) or another type of dynamic storage device that stores information and instructions for execution by processor 260. Memory 230 may also store temporary variables or other intermediate information used during execution of instructions by processor 260. ROM 240 may include a conventional ROM device or another type of static storage device that stores static information and instructions for processor 260. Storage device 270 may include a compact disc (CD), digital video disc (DVD), a magnetic medium, or other type of storage device for storing data and/or instructions for processor 260. Communication interface 280 may include a wired or wireless interface for communicating to other devices via network 102.

Input device 220 may include a keyboard, a pointing device or other input device. Output device 250 may include one or more conventional mechanisms that output information, including one or more display screens, or other output devices.

Processing device 200 may perform such functions in response to processor 260 executing sequences of instructions contained in a tangible machine-readable medium, such as, for example, memory 230, ROM 240, storage device 270 or other medium. Such instructions may be read into memory 230 from another machine-readable medium or from a separate device via communication interface 280.

### Exemplary Displays

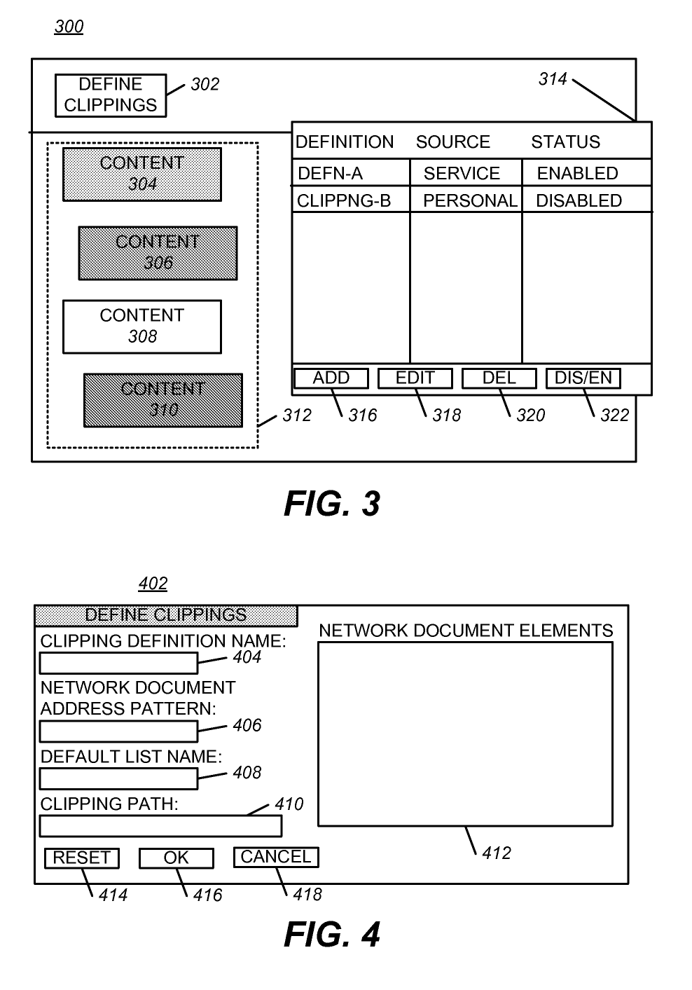

FIG. 3 illustrates an exemplary display 300 in an embodiment consistent with the subject matter of this disclosure. Display 300 may be a display from a network browser showing a network document including content 304, content 306, content 308, and content 310. A user desiring to define clippable sections of the network document, may select control 302 to indicate a desire to define the clippable sections. Control 302 may be selected with a pointing device, such as, for example, a computer mouse, or other device.

Upon selecting control 302, menu 314 may be displayed. Menu 314 may include one or more names of clippable section definitions, which may be applicable to a currently displayed network document (in this example, “DEFN-A” and “CLIPPNG-B”), respective sources of the one or more clippable section definitions (in this example, “Service” may indicate a predefined clipping definition defined by a clipping service, and “Personal” may indicate a clipping definition defined by the user), and a status of the clipping definition (for example, “Enabled” may indicate that the clipping definition is active for one or more network documents, and “Disabled” may indicate that the clipping definition is inactive for the one or more network documents).

The user may select one of the clippable section definitions from menu 314 and may further select Edit 318 to edit the selected one of the clippable section definitions, may select Del 320 to delete the selected one of the clippable section definitions, or may select Dis/En 322 to enable a selected disabled clippable section definition or to disable a selected enabled clippable section definition. The user may select Add 316 to add a new clippable section definition.

Upon selecting Add 316 or Edit 318, menu 402 (FIG. 4) may be displayed. Via menu 402, the user may provide clippable section definition name in a window 404, may provide a network document address pattern in a window 406, may provide a default list name in a window 408, and may edit a clipping path in a window 410.

The clippable section definition name, to be provided in window 404, may be a name of to the clippable section definition that the user is about to add or edit. The network document address pattern may define an address pattern, such that a clippable section definition named in window 404 may be defined for network documents having addresses which match the address pattern. For example, clippable section definitions with respect to network documents showing results of a search by a search engine may be associated with an address pattern of “http://www.searchengine.com/search*”. That is, search results from a search engine called “searchengine” may be provided in a form of a network document having an address which matches the above-mentioned address pattern, where “*” in the above example may indicate that a portion of the address pattern after “http://www.searchengine.com/search” is to be ignored. That is, a clippable sections definition may apply to network documents matching at least a partial address. The default list name, to be provided in window 408, may be a name of a default list to which content of selected clippable sections defined by a clippable section definition, as named in window 404, may be saved. Clipping path, which may be shown in window 410, may show a path defining clippable sections of a network document. In one embodiment, the path may be displayed as XPath text. Network document elements may be displayed in window 412. In one embodiment, the network document elements may include eXtensible Markup Language (XML) tags or HyperText Markup Language (HTML) tags.

In addition to menu 402 being displayed, upon selecting Add 316 or Edit 318, a DOM of the network document may be walked to determine a repeating pattern within the DOM. After finding a first repeating pattern, a visual indicator may be displayed to indicate clippable sections of the network document, as are currently defined. As an example, dashed line 312 (FIG. 3) may indicate a current definition of the clippable sections of the network document. The visual indication may further show repeatable patterns within one or more defined clippable sections. For example, content 304, content 306, content 308, content 310 may be repeatable patterns, which may be indicated by being shaded by different colors on display 300. A user may select content 304, content 306, content 308, or content 310 with a pointing device or other device, thereby causing the DOM of the network document to be walked to determine a repeating pattern corresponding to the selected one of contents 304, 306, 308, 310, within dashed line 312. Dashed line 312 may then be redrawn around the selected one of contents 304, 306, 308, 310 and repeating patterns within redrawn dashed line 312 may be indicated by being shaded in different colors.

Referring back to FIG. 4, selecting Reset 414 may cause current defined clippable sections to be reset back to original settings, as the settings were when the user first began to define the clippable sections with respect to the network document.

In the above example, the user may continue to drill down to other repeating patterns by continuing to select content of the network document. Similarly, the user may change the current definition of the clippable sections to find a repeating pattern upward, or outside of a current defined clippable section by, for example, holding a particular key down while selecting a clippable section, or by other means.

To save a definition of the current clippable sections, the user may select OK 416. To cancel the defining of the clippable sections, the user may select CANCEL 418.

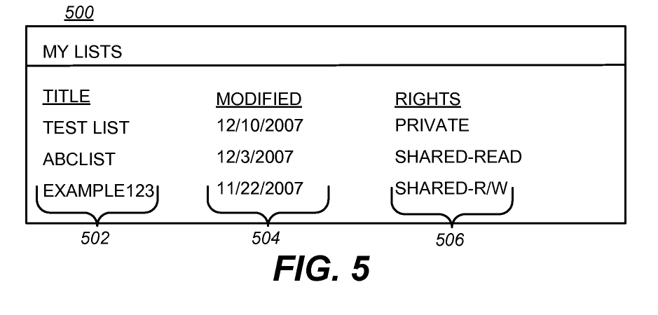

The user may request to view lists including saved clippable content. For example, in an embodiment including a network browser, the user may select a control for viewing the lists. In some embodiments, the lists may be stored on a server, such as server 106. FIG. 5 shows an exemplary display 500, which may be displayed after the user requests to view the lists. Exemplary display 500 shows a title 502 of each list, a date 504 each list was last modified, and sharing rights 506. In this example, the sharing rights may be “private” indicating that the list may only be viewed by the user who created the list, “shared-read” indicating that the list may be read by other users, and “shared-r/w” indicating that the list may be read and written by other users.

Display 500 is only exemplary. In other embodiments, other information pertaining to the list may be displayed, and the lists may include different or other rights.

### Exemplary Processing

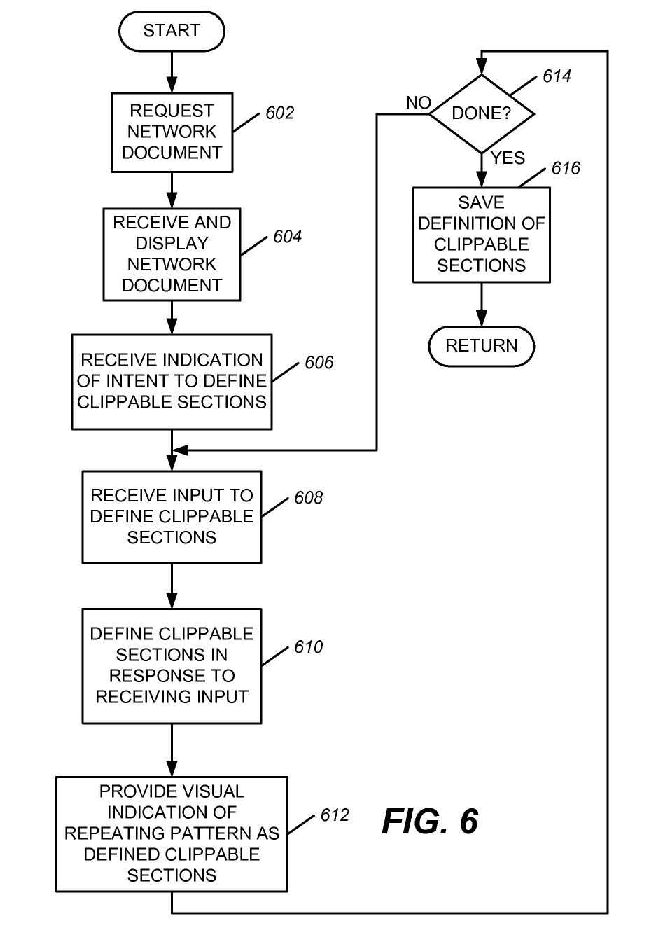

FIG. 6 is a flowchart of an exemplary process for defining clippable sections of a network document in embodiments consistent with the subject matter of this disclosure. The process may begin with a request for a network document (act 602). For example, in an embodiment in which a browser is executed on a processing device, a user may request a network document via the browser. The processing device may receive the network document and may display the network document via the browser (act 604). Next, the user may indicate an intent to define clippable sections with respect to the displayed network document (act 606).

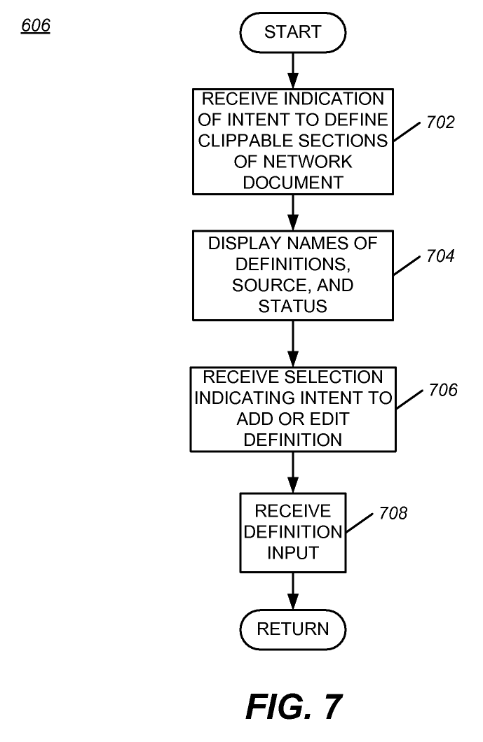

FIG. 7 is a flowchart illustrating exemplary processing with respect to act 606 of FIG. 6. The process may begin with the processing device receiving the indication of the intent to define clippable sections of the network document (act 702). The processing device may then display a menu, such as, for example, menu 314 (FIG. 3), which may include names of definition lists, sources of each of the lists, and a status of each of the lists (act 704).

The processing device may then receive a selection indicating an intent to add or edit a definition (act 706). In one embodiment, the user may select Add 316 (FIG. 3) to indicate an intent to add a new definition, or the user may select one of the displayed definition names and Edit 318 to indicate an intent to edit a definition corresponding to the selected displayed definition name. The processing device may then receive input for defining clippable sections, as previously described with respect to FIGS. 3 and 4 (act 708).

Returning to FIG. 6, the processing device may receive one or more commands to define clippable sections of the network document (act 608). The commands may be in a form of selecting a section of the network document including content, modifying a displayed clipping path, or selecting a network document element, as previously described with respect to FIGS. 3 and 4, or via other methods.

The processing device may then define clippable sections of the network document in response to receiving one or more inputs or commands to define the clippable sections (act 610).

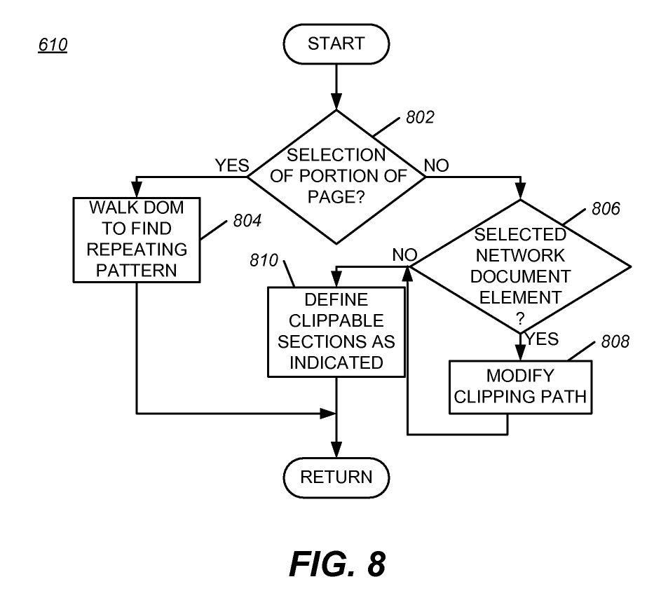

FIG. 8 is a flowchart illustrating an exemplary processing for performing act 610 of FIG. 6. The process may begin with the processing device determining whether or a portion of the network document, including content, was selected as part of defining the clippable sections (act 802). If the processing device determines that the portion of the network document was selected, then the processing device may walk a DOM, corresponding to the displayed network document, to find a repeating pattern, as previously described with respect to FIG. 3 (act 804). The process may then be completed.

If, during act 802, the processing device determines that the portion of the network document was not selected, then the processing device may determine whether the user selected a network document element, as previously described with respect to FIG. 4 (act 806). If the processing device determines that the network document element was selected, then the processing device may modify a clipping path, as illustrated in window 410 (FIG. 4), to reflect the selected network document element (act 808) and the processing device may define the clippable sections of the network document as indicated (act 810). If the processing device determines, during act 806, that the user did not select a network document element, then the processing device may assume that the user modified a clipping path, as shown in window 410 and the processing device may define the clippable sections of the network document as indicated (act 810). The process may then be completed.

Returning to FIG. 6, the processing device may provide a visual indication of a repeating pattern as currently defined clippable sections, as described above with respect to FIG. 3 (act 612). The processing device may then determine whether the process for defining the clippable sections is completed (act 614). For example, the process may be completed when the user selects OK 416 from menu 402 (FIG. 4). If the process is completed, then the processing device may save the definition of the clippable sections with respect to the network document (act 616). In some embodiments, the definition may be saved to a storage device, locally, with respect to the processing device. In other embodiments, the processing device may send the definition to a remote processing device, such as a server, where the definition may be saved. The process may then be completed.

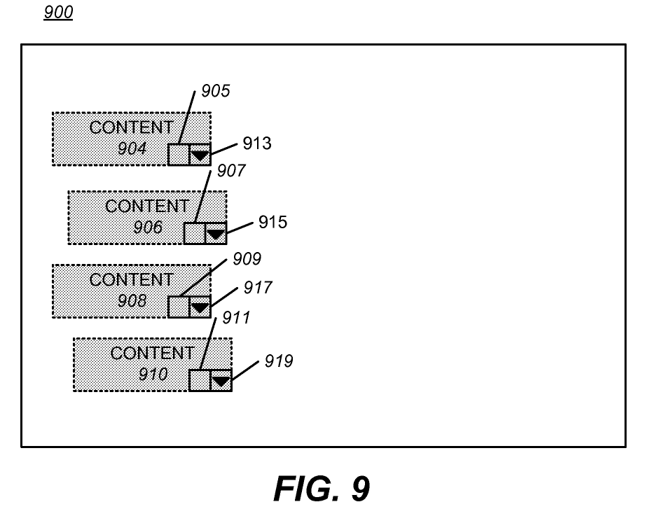

FIG. 9 illustrates an exemplary display of a network document including content 904, content 906, content 908, and content 910. Each of contents 904, 906, 908, 910 is bounded by a dashed line, which in this example, indicates a clippable section. The user may select one of contents 904, 906, 908, 910, such that corresponding content may be saved to a list. Content with respect to 904, 906, 908, and 910 may be selected for saving by the user selecting a saving indicator 905, 907, 909, one 911, respectively. In some embodiments, the user may select a list indicator 913, 915, 917, or 919, which may cause a menu to be displayed showing a number of lists to which selected content of a clippable section may be saved.

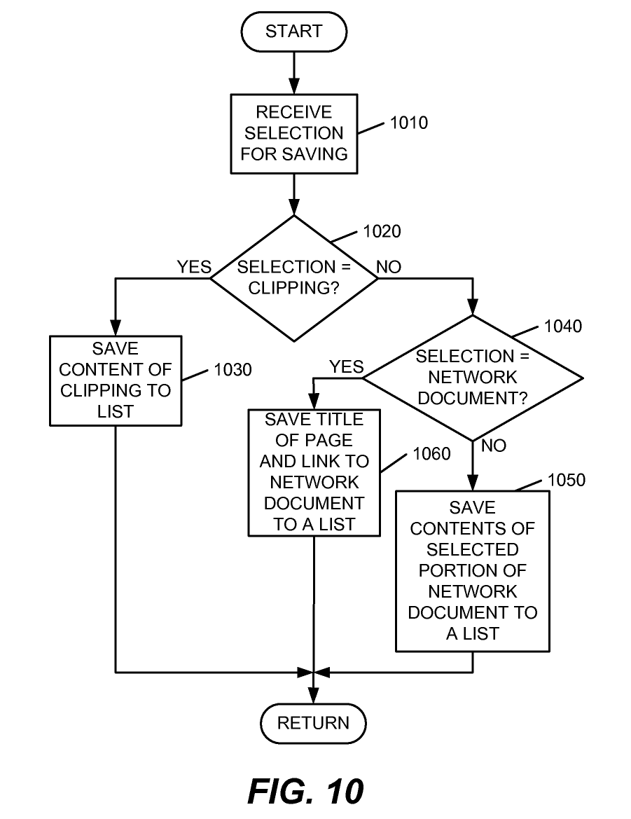

FIG. 10 is a flowchart illustrating an exemplary process for saving content of a network document to a list. The process may begin with receiving of a selection indicating a desire to save content with respect to the network document (act 1010). The processing device may then determine whether the selection corresponds to a defined clippable section (act 1020). If the selection corresponds to a defined clipping section, then the processing device may save content corresponding to the defined clipping section to a list (act 1030). As mentioned previously, the list may be stored locally, with respect to a user's processing device. In other embodiments, the list may be saved to a remote processing device, such as, for example, a server.

If, during act 1020, the processing device determines that the selection does not correspond to defined clippable section, then a processing device may determine whether the selection corresponds to an entire network document (act 1040). If the user's processing device determines that the selection does not correspond to an entire network document, then the user's processing device may assume that a portion of the network document was selected for saving, as previously discussed with respect to FIG. 9. The processing device may then save contents of the selected portion of the network document to a list (act 1050).

In some embodiments, definitions of clippable sections may be saved on a remote processing device, such as a server. In such embodiments, when the user's processing device receives an indication of a desire to define clippable sections for a network document, menu 1102 may be displayed, instead of menu 314. Menu 1102 may include names of definitions of clippable sections, sources of the definitions definitions, and statuses of the definitions. A source of a definition, in this embodiment, may be “service”, indicating a definition defined by a network document clipping service, “personal”, indicating a definition defined by the user, or “comm”, indicating a definition shared in common with other users. A status of a definition may be “enabled”, indicating that the definition is active for network documents matching a network document address pattern, “disabled” indicating that the definition is inactive, or “unloaded”, indicating that the definition is not loaded into the user's processing device.

Add 1104, Edit 1106, Del 1108, and Dis/En 1110 may function in a same manner as Add 316, Edit 318, Del 320, and Dis/En 322, with respect to FIG. 3. Selection of Load 1112 may cause a selected definition to be loaded from the server to the user's processing device and enabled. Selection of Unload 1114 may cause a selected definition, which was previously loaded, to be removed, or unloaded, from the user's processing device.

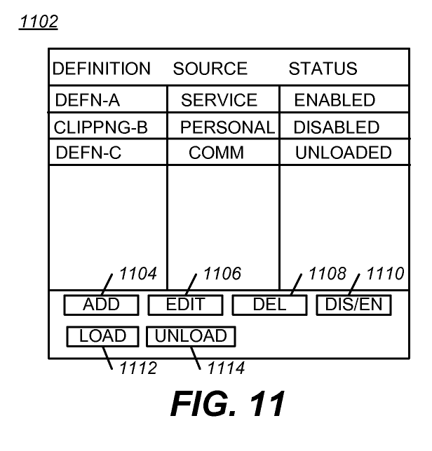

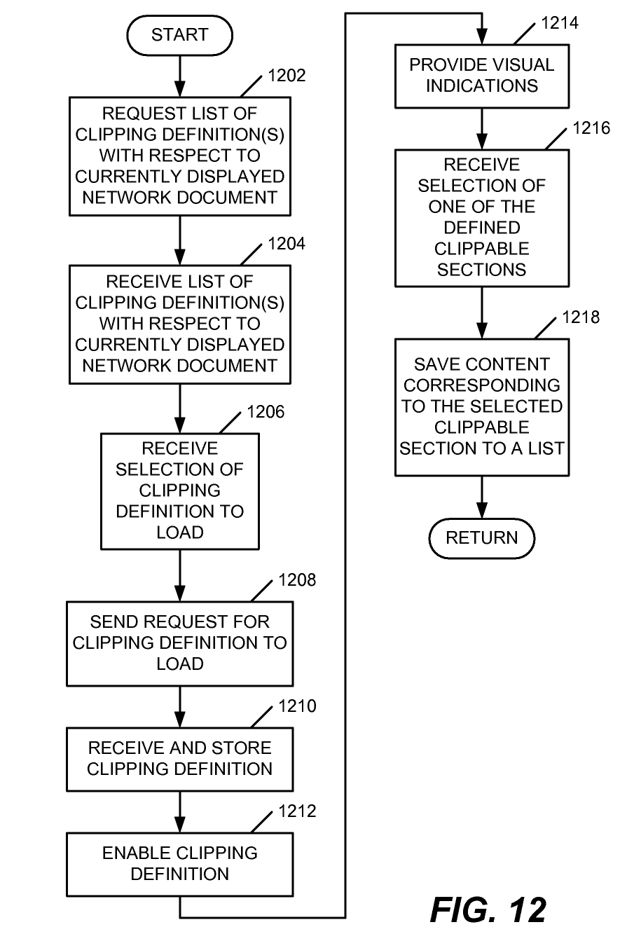

FIG. 12 is a flowchart of an exemplary process for loading a definition of clippable sections to a user's processing device from a remote processing device, such as, for example, a server. The process may begin with the user's processing device sending a request to the server for a list of defined clippable sections (act 1202). The user's processing device may then receive, from the server, the list of defined clippable sections (act 1204), which may be displayed as a menu, such as menu 1102 (FIG. 11).

The processing device may then receive a selection of one of the clippable sections definitions for loading to the user's processing device (act 1206). As a result of receiving the selection of one of the clippable sections definition, the user's processing device may send a request to the server for the selected clippable sections definition (act 1208). The user's processing device may then receive and store the requested clipping definition (act 1210). The user's processing device may then enable or activate the stored clippable sections definition (act 1212) and may provide visual indications (act 1214), such as, for example, the visual indications discussed earlier, with respect to FIG. 3. The user's processing device may then receive a selection of one or more of the clippable sections definition of the network document (act 1216) from the user and may save content corresponding to the selected one or more clippable sections to a list, which may be stored on a storage device of the server (act 1218).

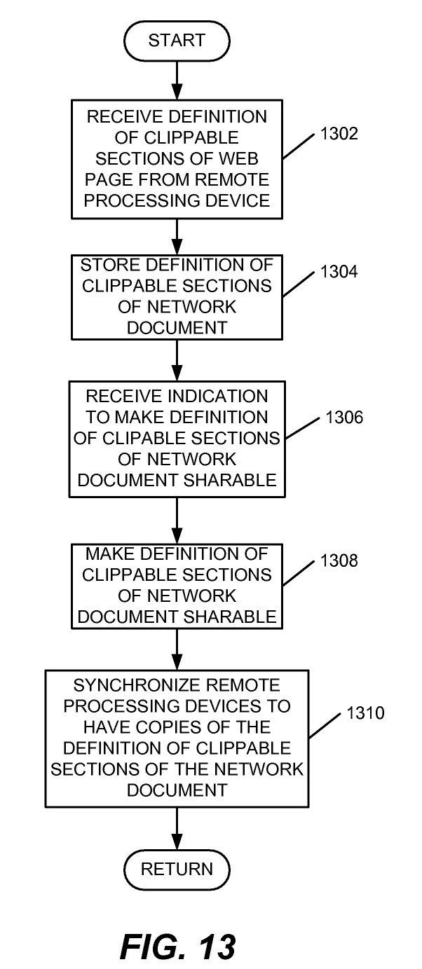

FIG. 13 is a flowchart of an exemplary process which may be performed in a server, which may store clippable sections definitions defined by users, in an embodiment consistent with the subject matter of this disclosure. The process may begin with the server receiving a clippable sections definition of a network document from a remote processing device, which may be a user's processing device (act 1302). The server may store the definition of clippable sections to a storage device of the server (act 1304). The server may receive an indication from the user's processing device indicating that the definition is to be made shareable with other users (act 1306). The server may then make the stored definition shareable with other users (act 1308). In some embodiments, the server may synchronize one or more remote users' processing devices to have copies of the definition (act 1310). The process may then be completed.

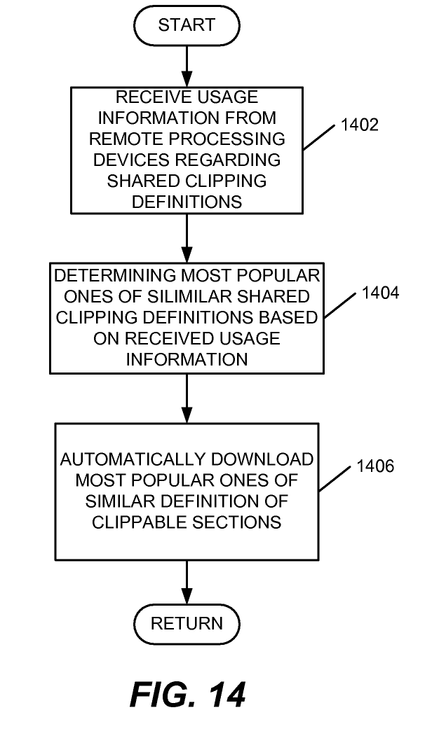

FIG. 14 is a flowchart illustrating an exemplary process which may be performed in a server in some embodiments. The process may begin with the server receiving usage information from users' processing devices, with respect to usage of clippable section definition shared with other users (act 1402). The server may then determine most popular ones of similar shared clipping definitions based on the usage information received from the users' processing devices (act 1404). The server may then automatically download up to a predetermined number of the most popular ones of the similar clipping definitions to the users' processing devices (act 1406).

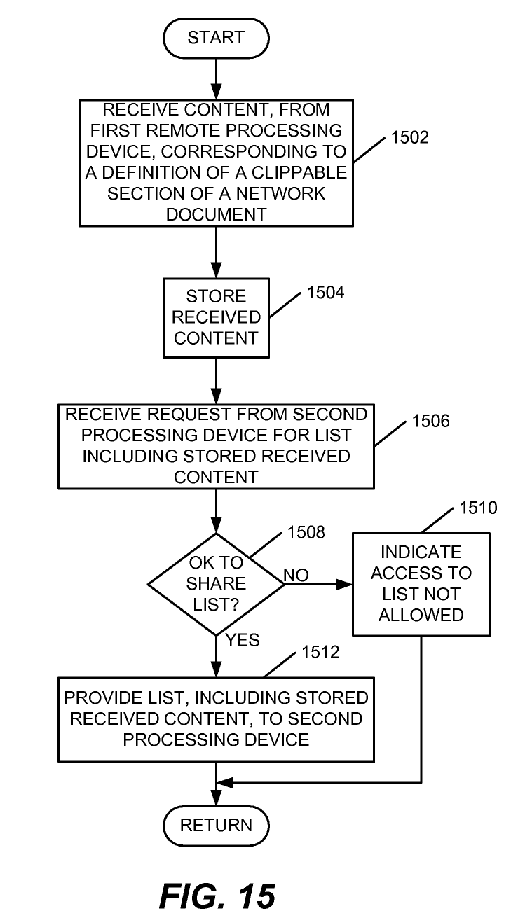

FIG. 15 is a flowchart illustrating an exemplary process for storing content corresponding to a clippable section definition and sharing the stored content with another user. The process may begin with a server receiving content corresponding to a clippable section definition from a first remote processing device, such as, for example, a first user's processing device (act 1502). The server may then store the received content to a list (act 1504). Some time later, the server may receive a request from a second remote processing device, such as, for example, a second user's processing device, for a list including the stored received content (act 1506). The server may then determine whether the list may be shared with other users (act 1508). If the list may not be shared with other users, then the server may provide an indication to the second remote processing device that access to the list is not allowed (act 1510). Otherwise, the server may provide the requested list, including the stored received content, to the second processing device (act 1512).

### CONCLUSION

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they are not be construed as limiting the claims in any way. Other configurations of the described embodiments are part of the scope of this disclosure. Further, implementations consistent with the subject matter of this disclosure may have more or fewer acts than as described, or may implement acts in a different order than as shown. Accordingly, only the appended claims and their legal equivalents define the invention, rather than any specific examples given.

1. A method for defining clippable sections of a network document, the method comprising:
displaying a network document on a display monitor of a processing device;
receiving an input for defining the clippable sections via use of a pointing device pointing to a portion of the network document;
walking a document object model of the network document to find a repeating pattern of the document object model, which includes the portion of the network document; and
providing visual indications of the repeating pattern, as the defined clippable sections, on the displayed network document.

2. The method of claim 1, further comprising:
receiving a second input for refining the defined clippable sections via use of the pointing device;
walking the document object model of the network document to find a second repeating pattern within the first repeating pattern; and
providing second visual indications of the second repeating pattern, as the defined clippable sections, of the displayed network document.

3. The method of claim 1, further comprising:
receiving a second input for defining the defined clippable sections via the pointing device;
walking the document object model of the network document to find a second repeating pattern outside the defined clippable sections; and
providing second visual indications of the second repeating pattern, as the revised defined clippable sections.

4. The method of claim 1, further comprising:
displaying a clipping path, with respect to the document object model, corresponding to the defined clippable sections; and
revising the defined clippable sections in response to receiving input modifying the displayed clipping path, the revised defined clippable sections corresponding to the modified displayed clipping path.

5. The method of claim 1, further comprising:
receiving a selection of one of the defined clippable sections for saving; and
saving content of the selected one of the defined clippable sections to a list.

6. The method of claim 1, further comprising:
receiving a selection of one of the defined clippable sections for saving; and
sending the selected one of the clippable sections to a remote device to be saved to a list.

7. The method of claim 1, further comprising:
displaying a plurality of second visual indications in a plurality of colors showing at least two repeating patterns within one of the defined clippable sections.

8. The method of claim 1, further comprising:
receiving at least a partial address corresponding to at least one network document for which the defined clippable sections are applicable.

9. A processing device comprising:
at least one processor; and
a memory connected to the at least one processor, the memory comprising:
instructions for requesting, receiving, and displaying a network document via a network,
instructions for receiving an input to define clippable sections of the network document, and
instructions for walking a document object model of the network document, in response to receiving the input to define the clippable sections of the network document, to find a repeating pattern of the document object model and to define the repeating pattern as the clippable sections without executing a script.

10. The processing device of claim 9, wherein the memory further comprises:
instructions for receiving a selection of a portion of the network document, and
instructions for saving content of the selected portion of the network document to a list.

11. The processing device of claim 9, wherein the memory further comprises:
instructions for receiving a selection of one of the clippable sections from the defined clippable sections of the network document, and
instructions for sending content of the one of the selected clippable section to a remote processing device for saving to a list on the remote processing device, wherein
the list is accessible to other users.

12. The processing device of claim 9, wherein the memory further comprises:
instructions for receiving a selection of a network document to save, and
instructions for sending an address of the network document to a remote processing device to be saved in a list on the remote processing device.

13. The processing device of claim 9, wherein the memory further comprises:
instructions for requesting, receiving, and displaying a second network document via the network,
instructions for sending a request to a remote processing device for a clippable sections definition applicable to the second network document,
instructions for receiving the clippable sections definition with respect to the second network document,
instructions for providing visual indications with respect to portions of the displayed second network document corresponding to the received clippable sections definition,
instructions for receiving a selection of one of the portions of the second network document, and
instructions for causing content corresponding to the selected one of the portions of the displayed network document to be saved.

14. A method for providing a clipping service via a network, the method comprising:
receiving, from a remote processing device, a definition of clippable sections of a network document;
storing the definition of the clippable sections of the network document; and
making the definition of the clippable sections of the network document sharable.

15. The method of claim 14, further comprising:
synchronizing a plurality of remote processing devices such that the remote processing devices have copies of the definition of the clippable sections of the network document.

16. The method of claim 14, further comprising:
receiving usage information, from a plurality of remote processing devices, with respect to shareable definitions of clippable sections of network documents;
determining most popular ones of similar ones of the shareable definitions of clippable sections of network documents, based, at least in part, on the received usage information; and
automatically downloading, to the plurality of remote processing devices, up to a predetermined number of the most popular ones of the similar ones of the shareable definitions of clippable sections of network documents.

17. The method of claim 14, further comprising:
receiving content, from the remote processing device, corresponding to a definition of a particular clippable section of a network document;
storing the received content;
receiving a request for the stored received content from a second processing device; and
providing the stored received content to the second remote processing device.

18. The method of claim 14, further comprising:
receiving, from the remote processing device, a plurality of definitions of clippable sections of the network document; and
storing the plurality of definitions of the clippable sections of the network document.

19. The method of claim 14, further comprising:
receiving at least a partial address corresponding to at least one network document for which the definition of the clippable sections apply.

20. The method of claim 14, further comprising:
receiving an address corresponding to at least one network document for which the definition of the clippable sections apply, wherein
the address includes an ignore indicator such that the definition of the clippable sections applies to network documents having corresponding addresses which match portions of the received address excluding the ignore indicator.
